(19) United States
(12) Patent Application Publication
(10) Pub. No.: US 2010/0262997 A1
(43) Pub. Date: Oct. 14, 2010

(54) SYSTEMS AND METHODS FOR CATCH-UP ELECTRONIC PROGRAM GUIDE

(75) Inventor: Antony Dove, Queensbury (GB)

Correspondence Address: Black Lowe & Graham PLLC, 701 Fifth Avenue, Suite 4800, Seattle, WA, 98104, US

(73) Assignee: Eldon Technology Limited, Keighley (GB)

(21) Appl. No.: 12/423,630

(22) Filed: Apr. 14, 2009

(51) Int. Cl. H04N 5/445; H04N 5/44

(52) U.S. Cl. 725/44; 348/734; 725/51; 348/E05.096

(57) ABSTRACT

Catch-up electronic program guide (EPG) systems and methods are operable to present information pertaining to previously available programs. An exemplary embodiment retrieves program information pertaining to a plurality of programs from a memory, wherein the retrieved program information identifies at least a scheduled presentation time of each of the plurality of programs; compares a current time with the scheduled presentation times of the plurality of programs; identifies programs that are no longer available for presentation based upon the compared current time and the scheduled presentation times; and generates a catch-up EPG based upon the identified programs that are no longer available for presentation.

### BACKGROUND

Electronic program guides (EPGS) are presented on a display device to assist a viewer to select programming of interest. An EPG is a type of a user interface that presents a menu, or a series of menus, with a combination of text and symbols to represent viewing choices that may be selected by the viewer.

Typically, an EPG has the look and feel of a table with information describing available programs. The available program information may include the title of available programming, along with the scheduled time and date of the program presentation. A brief description of the program may also be provided on the EPG. The EPG typically indicates the “channel” of the available program. The channel identifies the originating source of the program, such as a television studio, a premium movie provider, a national program provider, etc.

EPGs are interactive with the viewer. The viewer, via their control unit that is in communication with a media device that is presenting the EPG on the display, is able to “scroll” or “navigate” about the EPG to select a program of interest. When the viewer highlights the portion of the EPG corresponding to a program of interest, the viewer may actuate one or more controllers to cause the media device to perform a function relative to the selected program of interest. For example, if the program of interest is scheduled to begin, or is currently available, the viewer may select the program of interest for presentation on the display. Alternatively, or additionally, the viewer may have the media device record and store the program of interest in a memory such that the viewer may later view the program at a more convenient time.

Conventional EPGs present programming information for currently available and for future scheduled programs. Some EPGs may show scheduled programs that have already started by presenting the first entries on the EPG based on a predefined time increment, such as an hour or a half hour. For example, if the current time is 8:50 p.m., then the EPG may begin presentation of the program scheduling information at 8:30 p.m., or at 8:00 p.m. Thus, the user is able to appreciate what programs are currently being presented, or possibly may appreciate programs that have recently concluded.

However, the viewer is unable to cause the EPG to scroll backwards in time and present information for previously presented programs. That is, if the current time is 8:50 p.m., the viewer cannot use the EPG to view programming that was presented earlier in the evening, in the afternoon, in the morning, or even in preceding days. For example, the viewer may know that one of their favorite programs is presented sometime tonight, but may not be able to remember the particular scheduled time for the program of interest. By viewing the conventional EPG, the viewer is only able to determine if their program of interest is being currently presented, or if their program of interest will be presented later that night and/or at a future date. The viewer cannot tell if their program of interest has already been presented. Even if the viewer appreciates that they have already missed the presentation of their program of interest, they are unable to determine information about the missed program of interest (such as, but not limited to, which episode the program of interest was, whether the program of interest was new or a repeat, or the subject matter of the missed program of interest).

To find information pertaining to a previously presented program of interest, a viewer must go to a remote source, such as the internet, a printed program guide, the newspaper, or the like. Accordingly, there is a need for allowing a user to access information pertaining to programs of interest that have already been presented.

### SUMMARY

Catch-up electronic program guide (EPG) systems and methods are operable to present information pertaining to previously available programs. An exemplary embodiment retrieves program information pertaining to a plurality of programs from a memory, wherein the retrieved program information identifies at least a scheduled presentation time of each of the plurality of programs; compares a current time with the scheduled presentation times of the plurality of programs; identifies programs that are no longer available for presentation based upon the compared current time and the scheduled presentation times; and generates a catch-up EPG based upon the identified programs that are no longer available for presentation.

### BRIEF DESCRIPTION OF THE DRAWINGS

Preferred and alternative embodiments are described in detail below with reference to the following drawings:

FIG. 1 is a block diagram of an embodiment of the catch-up electronic program guide (EPG) system;

FIG. 2 is a block diagram of a current EPG generated by an embodiment of the catch-up EPG system; and

FIG. 3 is a block diagram of a catch-up EPG generated by an embodiment of the catch-up EPG system.

### DETAILED DESCRIPTION

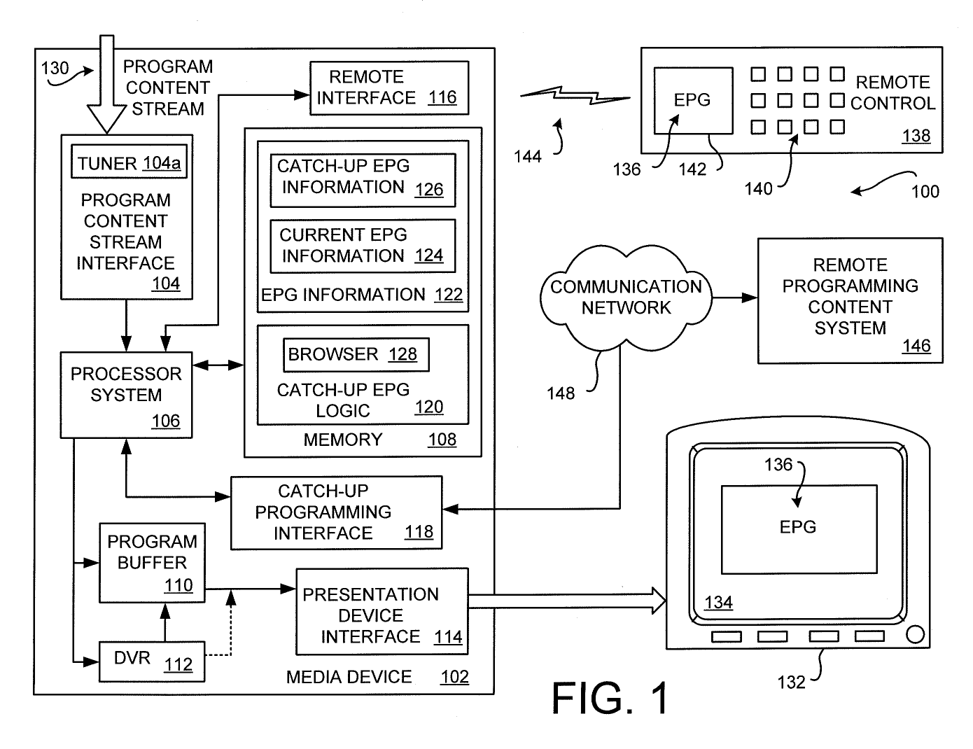

FIG. 1 is a block diagram of an embodiment of a catch-up electronic program guide (EPG) system 100 that is operable to control a media device 102, such as, but not limited to, a set top box (STB). Embodiments of the catch-up EPG system 100 may be implemented in other media devices, such as, but not limited to, stereos, radios, televisions (TVs), digital video disc (DVD) players, digital video recorders (DVRs), or personal computers (PCs).

Embodiments of the catch-up EPG system 100 are operable to present a catch-up EPG that presents program information pertaining to programs of interest that have been previously available for presentation. In some embodiments, previously available programs that are available from another source and/or that may be available at another future time and/or date may be indicated as such. Previously available programs that are not available from other sources, that are not scheduled for future presentation, and/or where no information is known, are also indicated. Various embodiments are further operable to locate and retrieve one or more previously available programs of interest in response to a viewer request.

The non-limiting exemplary media device 102 comprises a program content stream interface 104, a processor system 106, a memory 108, a program buffer 110, an optional digital video recorder (DVR) 112, a presentation device interface 114, a remote interface 116, and an optional catch-up programming interface 118. The memory 108 comprises portions for storing the catch-up EPG logic 120 and EPG information 122. The EPG information 122 includes current EPG information 124, which has program information pertaining to programs that are currently available or that will be available in the future, and catch-up EPG information 126, which has program information for previously available programs. In some embodiments, an optional browser 128 or the like may be integrated into the catch-up EPG logic 120. Alternatively, the browser 128 may be separately implemented as part of another component and/or function. Other media devices may include some, or may omit some, of the above-described media processing components. Further, additional components not described herein may be included in alternative embodiments.

The functionality of the media device 102, here a set top box, is now broadly described. One or more program content streams 130 are received by the program content stream interface 104. One or more tuners 104a in the program content stream interface 104 selectively tune to one of the program content streams 130 in accordance with instructions received from the processor system 106. A program content stream 130 typically comprises a plurality of programs multiplexed together. The processor system 106, based upon a request for a program of interest specified by a viewer, parses out program content associated with the program of interest. The program of interest is then assembled into a stream of video and/or audio information which may be saved into the program buffer 110 such that the program content can be streamed out to the media presentation device 132, such as the television, via the presentation device interface 114. Alternatively, or additionally, the parsed out program content may be saved into the DVR 112 for later presentation.

From time to time, program information updates are communicated to the media device 102, via the program content stream 130 or via another suitable media. The update information is used to populate the current EPG information 124 portion of the memory 108 with program information pertaining to the currently available or future scheduled programs. From time to time, as more current EPG information is received, the current EPG information 124 is updated.

In the various embodiments, the previous programming information is saved into the catch-up EPG information 126 portion of the memory 108. In some embodiments, the previously stored current EPG information (now a “stale” EPG) is saved as the catch-up EPG information 126. The previously available programs of interest may be identified based upon a comparison of a current time with the scheduled times of the plurality of programs identified in the “stale” EPG. The comparison may be performed periodically, such as every hour or half hour, and/or may be performed upon receipt of updated EPG information. That is, previously available programs of interest that are no longer available for presentation are identified, and information pertaining to those previously available programs of interest are used to update the catch-up EPG information 126.

Accordingly, an archive of historical program scheduling and program information is retrievable from the catch-up EPG information 126. Upon receipt of an instruction from the viewer requesting presentation of an EPG, the information in the current EPG information 124 and/or the catch-up EPG information 126 is retrieved, formatted, and then presented on the display 134 of the media presentation device 132 as an EPG 136.

The program information may include, but is not limited to, the scheduled presentation start and/or end time, the program channel, and descriptive information for the program. The program's descriptive information may include the title of the program, names of performers or actors, date of creation, and a summary describing the nature of the program. Any suitable information may be included in the program information.

The catch-up EPG system 100 embodiment implemented in the exemplary media device 102 is configured to receive instructions from a viewer via a suitable control device, such as, but not limited to, the exemplary remote control 138. The remote control 138 includes one or more controllers 140 and an optional display 142. The viewer, by actuating one or more of the controllers 140, causes the remote control 138 to generate and transmit instructions, via a wireless signal 144, to the media device 102 to control presentation of information shown on the EPG 136.

In some embodiments, the EPG 136 may be presented on the remote control display 142. Thus, the catch-up EPG system 100 would receive viewer generated instructions from the remote control 138, construct an EPG 136, and then transmit the EPG 136 back to the remote control 138 so that the EPG 136 is presented on the remote control display 142 in accordance with the viewer's instructions.

In other embodiments, selected EPG information is sent to the remote control 138. The remote control 138 then constructs and presents the EPG 136.

Alternatively, or additionally, the media device 102 may itself have one or more controllers thereon that are configured to receive instructions from the viewer. Thus, the viewer may input instructions to have the catch-up EPG system 100 generate and present the EPG 136 on an available display.

Some embodiments of the catch-up EPG system 100 include the catch-up programming interface 118. The catch-up programming interface 118 is configured to communicatively couple the media device 102 with a remote programming content system 146. The remote programming content system 146 contains an archive of programming that may be accessed by the catch-up EPG system 100 in the event that the viewer wishes to view a previously available program of interest. The catch-up programming interface 118 and the remote programming content system 146 may be directly communicatively coupled together using a suitable communication medium, or may be communicatively coupled together via the communication network 148.

The communication network 148 is illustrated as a generic communication system. In one embodiment, the communication network 148 comprises the Internet. Accordingly, the catch-up programming interface 118 is a modem or other type of Internet communication device. Alternatively, the communication network 148 may be a telephony system, a radio frequency (RF) wireless system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. In such embodiments, the catch-up programming interface 118 is configured to establish a communication link or the like with the communication network 148 on an as-needed basis, and is configured to communicate over the particular type of communication network 148 that it is coupled to.

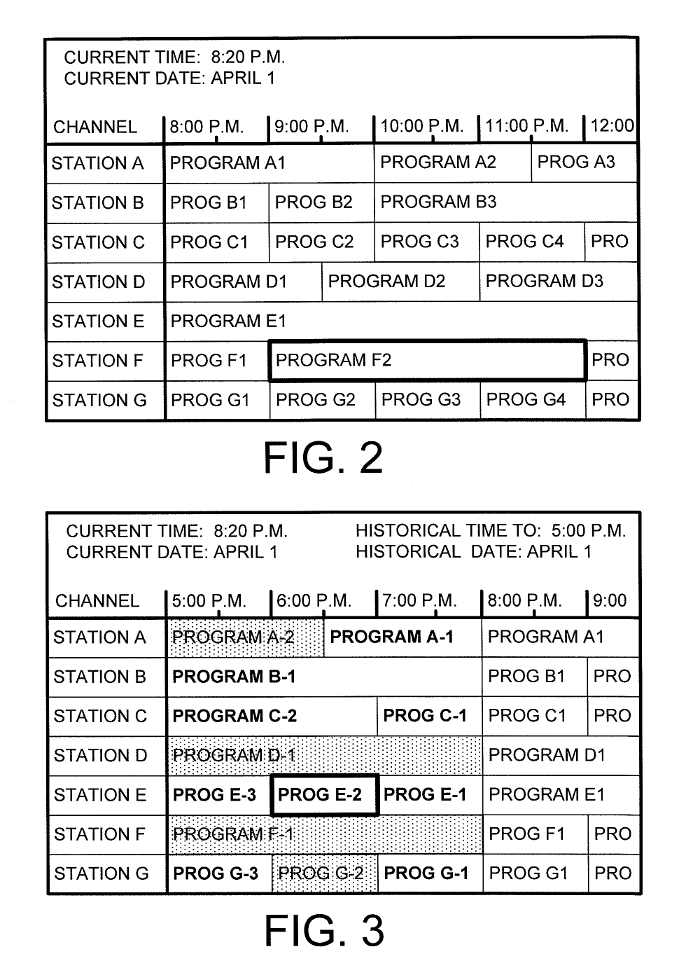

FIG. 2 is a block diagram of a hypothetical current EPG 202 generated by an embodiment of the catch-up EPG system 100. The current EPG 202 presents program information currently available for a plurality of programming channels.

The programming channels are identified by a suitable identifier, such as the name of the programming station or the like. Here, the seven channels are identified as stations A-G. The media device 102 is configured to present programming that is provided by many different programming channels, sometime even several hundreds of different programming channels. Accordingly, the viewer is able to navigate about the current EPG 202 so as to be able to view program information provided on one or more programming channels of interest.

Here, it is presumed that the viewer wishes to view an EPG that provides information pertaining to currently available programs. In this example, the current time is 8:20 p.m. on April 1. The information provided in the current EPG 202 is based on information in the current EPG information 124 portion of the memory 108 (FIG. 1), which is updated from time to time.

Programs that are available at the current time of 8:20 p.m. are identified on the current EPG 202. In this exemplary current EPG 202, programs currently available are shown adjacent to the programming channel on which they are available. For example, program A1 is currently available on the programming channel identified as “Station A” (and so on).

The current EPG 202 illustrates available programming by presenting the first program entries on the current EPG 202 based on a predefined time increment, such as an hour or a half hour. For example, since the current time is 8:20 p.m., the exemplary current EPG 202 begins presentation of the program scheduling information at 8:00 p.m. Thus, the viewer is able to appreciate which programs are currently available for viewing.

The current EPG 202 also provides information pertaining to a program that will be available in the future. The future time period extends out to some predefined time, which is limited by the available display size for the current EPG 202. In this simplified example, the time available for showing future program information extends out for four and one half hours, or out to 12:30 a.m.

In this simplified example, the viewer is assumed to be interested in viewing Program F2, which is scheduled for presentation at 9:00 p.m. on Station F, as conceptually illustrated by the bold outlining of that program. The viewer navigates through the current EPG 202 to the program of interest (Program F2), which becomes highlighted or emphasized in a suitable manner.

Then, the viewer may provide instructions pertaining to the program of interest. For example, the viewer may instruct the media device 102 to present the Program F2 when presentation of the program begins at 9:00 p.m. Alternatively, or additionally, the viewer may instruct the media device 102 to record and store the Program F2 in the DVR 112 (FIG. 1) or in another suitable memory media (not shown).

FIG. 3 is a block diagram of a catch-up EPG 302 generated by an embodiment of the catch-up EPG system 100. The illustrated catch-up EPG 302 conceptually demonstrates operation of an embodiment of the catch-up EPG system 100 that presents program information pertaining to programs that have already been available for presentation, and therefore, are no longer available for viewing.

Here, it is presumed that the viewer wishes to view an EPG that provides information pertaining to previously available programs. In this simplified example, the current time is 8:20 p.m. on April 1. The information provided in the catch-up EPG 302 is based on information in the catch-up EPG information 126 portion of memory 108 (FIG. 1). The catch-up EPG information 126 is updated from time to time with program information for programs having scheduled presentation times that have expired.

In this simplified example, the beginning time presented on the catch-up EPG 302 is 5:00 p.m. In some embodiments, previously available programs that are available from another source and/or that may be available at another future time may be indicated as such. For example, they may be indicated using a bold text font. In the non-limiting example of FIG. 3, the programs A-1, B-1, C-1, E-1, E-2, E-3, G-1, and G-3 are available from another source or will be available as some future date and/or time.

Previously available programs that are not available from other sources, that are not scheduled for future presentation, or where no information is known, are also indicated. For example, they may be indicated using using a grey background and a non-bold text font. In the non-limiting example of FIG. 3, the programs A-2, D-1, F-1, and G-2 are are not available from other sources, not scheduled for future presentation, or where no information is known.

Any suitable manner of distinguishing between previously available programs and presently available programs, such as background shading, background shading colors, text colors, text font style, text font size, and/or text type. In some embodiments, the previously available programs are not distinguished from presently available programs in any particular manner, but rather, the viewer is able to identify previously available programs based on the current time.

In some embodiments, the catch-up EPG 302 steps back in time by some predefined time increment, such as one hour, a half hour, or several hours. In other embodiments, the viewer interactively navigates through the catch-up EPG 302, and incrementally “pushes” the beginning time back by some predefined time increment. In some embodiments, the catch-up EPG 302 may be paged back by a predefined period of time (such as several hours) and/or may page back by one or more days. In some embodiments, the catch-up EPG 302 may have a specifiable beginning time and/or date. Alternative embodiments may provide multiple methods of adjusting the beginning time of the catch-up EPG 302.

To illustrate, assume that the viewer is interested in learning about the Program E-2, which was available for presentation on Station E earlier that day at 6:00 p.m. The viewer navigates back to the Program E-2, as conceptually illustrated by the bold outlining of that program. The catch-up EPG 302 then presents information pertaining to the Program E-2. For example, the catch-up EPG 302 shows the start and end time of presentation for the Program E-2. The catch-up EPG 302 may also present the title, and/or may present supplemental information, for the Program E-2.

Some embodiments of the catch-up EPG 302 may be configured to interactively accept further instructions from the viewer regarding a previously available program. For example, the user may input a command that causes the catch-up EPG system 100 to present additional supplemental information that has been saved into the catch-up EPG information 126 of the memory 108. Such additional information may include the names of selected actors, the subject matter of the previously available program, and/or the date of release for the previously available program. Any suitable supplemental information may be saved and presented on the catch-up EPG 302.

In some embodiments, the catch-up logic 120 may be configured to determine if a previously available program will be available for presentation at some future date and time. For example, the catch-up EPG system 100 may search the current EPG information 124 to identify if, and when, the Program E-2 is scheduled for a replay presentation at at least one future date and time. The program's replay information (date, time, and channel) may be presented to the viewer. In some embodiments, the viewer is able to select the replay of the future scheduled program for presentation and/or for recording into the DVR 112 or other suitable memory media (not shown).

In some embodiments, the catch-up logic 120 may be configured to search for the selected previously available program at other remote locations based upon a viewer instruction to replay the selected program of interest. For example, the catch-up EPG system 100 may search the remote programming content system 146 to determine if, and when, the Program E-2 is available for retrieving. Accordingly, the remote programming content system 146 retrieves the previously available Program E-2 from the remote programming content system 146. The retrieved Program E-2 may then be presented to the viewer and/or stored into the DVR 112 or other suitable memory media (not shown).

Some types of remote programming content systems 146 are configured to stream selected programs to connected devices. For example, the remote programming content system 146 may be operated by the organization providing programming on Channel E. The organization may interactively have the Program E-2 available for downloading or the like. Accordingly, in some embodiments, the catch-up EPG logic 120 is configured to establish a communication link to the remote programming content system 146 and download the previously available Program E-2.

Further, the catch-up EPG system 100 may use the browser 128 to search one or more remote programming content systems 146 to determine if, and when, the Program E-2 is available for downloading. Accordingly, the remote programming content system 146 locates and retrieves the previously available Program E-2 from the identified remote programming content system 146. The retrieved Program E-2 may then be presented to the viewer and/or stored into the DVR 112 or another suitable memory media (not shown).

The various embodiments of the catch-up EPG logic 120 may incorporate many features and formats when presenting programming information to the viewer. For example, the viewer may navigate backward in time, by hours, or even days, to learn about previously available programming. Sub-menus or other display formats may be used by the catch-up EPG logic 120 to present supplemental information to the viewer. As another example, more (or less) than the exemplary seven channels of available programming may be provided on the current EPG 202 and/or the catch-up EPG 302. As yet another example, the time period for which future or previous programming is shown may be extended out for several more hours. For brevity, the many different possible features and formats of presenting information pertaining to currently available programming and previously available programming on the current EPG 202 and/or the catch-up EPG 302 are not described herein.

In the simplified exemplary current EPG 202 (FIG. 2) and the simplified exemplary catch-up EPG 302 (FIG. 3), the program of interest was indicated by the bold outlining of that particular program. Any suitable type of highlighting or emphasis, such as, but not limited to distinctive fill pattern, fill color, text font, text color, and/or boundary type, may be used to identify a selected program of interest on the current EPG 202 and/or the catch-up EPG 302.

It should be emphasized that the above-described embodiments of the catch-up EPG system 100 are merely possible examples of implementations of the invention. Many variations and modifications may be made to the above-described embodiments. All such modifications and variations are intended to be included herein within the scope of this disclosure and protected by the following claims.

The embodiments of the invention in which an exclusive property or privilege is claimed are defined as follows:

1. A method for presenting information pertaining to previously available programs, the method comprising:
receiving program information pertaining to a first plurality of programs, wherein the received program information identifies at least a scheduled presentation time of each of the first plurality of programs;
storing the program information pertaining to the first plurality of programs into a memory;
after expiration of a predefined time period, identifying from the first plurality of programs a second plurality of programs, wherein the second plurality of programs are no longer available for presentation; and
generating a catch-up electronic program guide (EPG) based upon the identified second plurality of programs that are no longer available for presentation.

2. The method of claim 1, further comprising:
storing information corresponding to the catch-up EPG in the memory.

3. The method of claim 1, further comprising:
communicating information corresponding to the catch-up EPG to a remote control;
generating the catch-up EPG at the remote control; and
displaying the catch-up EPG on a display of the remote control.

4. The method of claim 1, further comprising:
periodically receiving updated program information, wherein the updated program information identifies at least the scheduled presentation time of a third plurality of programs scheduled for future presentation;
storing the updated program information pertaining to the third plurality of programs into the memory;
identifying from the first plurality of programs a fourth plurality of programs, that are no longer available for presentation; and
generating an updated catch-up EPG based upon the identified fourth plurality of programs that are no longer available for presentation.

5. The method of claim 1, further comprising:
distinguishing the identified second plurality of programs that are no longer available for presentation from a plurality of programs presently available for presentation on the catch-up EPG.

6. The method of claim 5, wherein distinguishing the identified second plurality of programs that are no longer available further comprises:
distinguishing with a first indication on the catch-up EPG a third plurality of programs that are available from at least one of another source and that will be available at at least a future time; and
distinguishing with a second indication on the catch-up EPG a fourth plurality of programs that are at least one of not available from the another source, not scheduled for future presentation, and where no information is known,
wherein the first indication is different from the second indication.

7. A method for presenting information pertaining to previously available programs, the method comprising:
retrieving program information pertaining to a plurality of programs from a memory, wherein the retrieved program information identifies at least a scheduled presentation time of each of the plurality of programs;
comparing a current time with the scheduled presentation times of the plurality of programs;
identifying programs that are no longer available for presentation based upon the compared current time and the scheduled presentation times; and
generating a catch-up electronic program guide (EPG) based upon the identified programs that are no longer available for presentation.

8. The method of claim 7, further comprising:
communicating the catch-up EPG to a display; and
presenting the catch-up EPG on the display, wherein the catch-up EPG presents the program information pertaining to the plurality of identified programs that are no longer available for presentation.

9. The method of claim 8, further comprising:
interactively receiving a viewer instruction, wherein the viewer instruction requests display of supplemental information pertaining to a selected program of interest, wherein the selected program of interest is one of the identified programs that are no longer available for presentation.

10. The method of claim 8, further comprising:
interactively receiving a viewer instruction, wherein the viewer instruction requests replay information of a selected program of interest, wherein the selected program of interest is one of the identified programs that are no longer available for presentation;
searching the retrieved program information pertaining to the plurality of programs from the memory to identify at least one future presentation of the selected program of interest; and
presenting a schedule of at least one future presentation of the selected program of interest.

11. The method of claim 10, further comprising:
interactively receiving an additional viewer instruction, wherein the additional viewer instruction causes a media device to schedule at least one of a presentation of the selected program of interest and a recording of the selected program of interest, wherein the presentation and the recording occurs at the scheduled future presentation of the selected program of interest.

12. The method of claim 8, further comprising:
interactively receiving a viewer instruction, wherein the viewer instruction requests at least one of a presentation of a selected program of interest and a recording of the selected program of interest;
searching at least one remote programming content system for availability of the selected program of interest; and
retrieving the selected program of interest in response to the selected program of interest being available at the at least one remote programming content system.

13. The method of claim 12, wherein searching the at least one remote programming content system comprises:
establishing a communication link through a communication network between a media device and the at least one remote programming content system; and
searching the at least one remote programming content system using a browser.

14. The method of claim 7, wherein the generated catch-up EPG includes identified programs that are no longer available for presentation between a first time and a second time.

15. The method of claim 14, wherein the first time is specified by a viewer.

16. A media device comprising:
a program content stream interface that receives a program content stream with a plurality of programs therein, and that receives electronic program guide (EPG) information that identifies at least a scheduled presentation time of each of the first plurality of programs; and
a processor system that is configured to, in response to receiving a viewer instruction requesting display of a catch-up EPG:
compare a current time with the scheduled presentation times of the plurality of programs;
identify programs that are no longer available for presentation based upon the compared current time and the scheduled presentation times; and
generate the catch-up EPG based upon the identified programs that are no longer available for presentation,
wherein the catch-up EPG is communicated to a display to present program information pertaining to the identified programs that are no longer available for presentation.

17. The media device of claim 16, further comprising:
a catch-up programming interface operable to receive a program of interest from a remote programming content system in response to receiving a viewer request for the program of interest, wherein the program of interest is one of the identified programs that are no longer available for presentation.

18. The media device of claim 16, further comprising:
a remote interface operable to receive the viewer instruction from a remote control.

19. A method for generating an electronic program guide (EPG) that provides information pertaining to programs that are no longer available for presentation, the method comprising:
receiving a viewer instruction requesting display of the EPG;
retrieving stored EPG information from a memory, the EPG information including at least scheduled presentation times of a plurality of programs;
comparing a current time with the scheduled presentation times of the plurality of programs;
identifying with a first indication a first plurality of programs that are no longer available for presentation based upon the compared current time and the scheduled presentation times, wherein the first plurality of programs are available from at least one of another source and that will be available at at least a future time;
identifying with a second indication a second plurality of programs that are no longer available for presentation based upon the compared current time and the scheduled presentation times, wherein the second plurality of programs are are at least one of not available from the another source, not scheduled for future presentation, and where no information is known, wherein the second indication is different from the first indication; and
generate the EPG based upon the identified programs that are no longer available for presentation,
wherein the EPG distinguishes the first plurality of programs that are no longer available for presentation with a first indication; and
wherein the EPG distinguishes the second plurality of programs that are no longer available for presentation with a second indication that is different from the first indication.

20. The method of claim 19, further comprising:
periodically receiving updated EPG information, wherein the previously stored EPG information becomes stale EPG information, and wherein the updated EPG information identifies a plurality of programs scheduled for future presentation;
storing the updated EPG information into a memory as current EPG information;
identifying from the stale EPG information additional programs that are no longer available for presentation; and
storing the identified program information for the additional programs that are no longer available for presentation.
